(19) United States
(12) Patent Application Publication
(10) Pub. No.: US 2016/0238235 A1
(43) Pub. Date: Aug. 18, 2016

(54) DIGITAL LAMPSHADE DISPLAY

(71) Applicants: Peter Garrett, Alameda, CA (US); Paul Regen, Felton, CA (US)

(72) Inventors: Peter Garrett, Alameda, CA (US); Paul Regen, Felton, CA (US)

(73) Assignee: Legacy IP, LLC

(21) Appl. No.: 14/622,731

(22) Filed: Feb. 13, 2015

(51) Int. Cl. F21V 33/00; G09G 5/00; F21S 10/00; F21S 6/00; F21V 1/00

(52) U.S. Cl. CPC F21V 33/0052; F21S 6/002; F21V 1/00; F21S 10/00; G09G 5/006; G09G 2370/02; G09G 2370/16; G09G 2380/02

(57) ABSTRACT

The Digital Lampshade Display system comprises a supporting a lamp fixture with stand structurally coupled to a base with conventional light fixture on the stand supporting a 3D conformable surface flexible display. The system controls the functions for the flexible 3D conformable surface display having external and internal surfaces for light emission, the display surface configured as a lampshade surrounding the conventional light fixture but also a flexible display screen for emitting diffuse light as a lampshade around a conventional light and electronically configurable to display downloaded static and video images.

### BACKGROUND

1. Field of the Invention

The present invention relates generally to the field of lighting and aesthetics; and more specifically to a digital lampshade which also serves as an electronic display of digital images and non-static motion imagery while emitting visible light.

2. Background Description

Recent advancements in lighting technologies have made it possible to deliver energy efficient, colorful, thin, and light-weight flexible digital displays. Organic Light Emitting Diodes (OLED), Active-Matrix Organic Light-Emitting Diodes (AMOLED), Organic Light Emitting Transistors (OLET), E-Ink and various other lighting and display technologies can now be used to create lighting and displays for the lighting and display industries.

The first generation flexible display technology had 16-bit grayscale with a low resolution. Currently displays using this technology, have diagonal screen, and can have the thickness of a sheet of paper. Its low resolution is explained by the fact that color is achieved by adding a filter on top of the grayscale screen. These displays emit sufficient light as to be daylight readable.

Flexible OLED technology displays don't need chips to create light, and they only need one piece of glass or even plastic or metal to serve as the substrate. These factors make it a better candidate for bending. OLEDs light up the screen with carbon-based materials that are deposited onto the surface, and that surface can then be shaped. Flexible OLED displays are light, thin, very flexible, and crucially, don't need to be covered in glass, so they can be flexed and twisted into most shapes. They also perform in a very similar way to existing AMOLED screens. Because there's no glass layer, there is nothing to break, at least brittle breaks.

Some of the screen technologies use all plastic, based on organic thin-film transistors (OTFTs), and the main structure of the backplane is made of polyethylene terephthalate (PET). On top of that are the OTFTs, made of other plastics.

Another flexible display technology uses a backplane which is then laminated to E Ink's frontplane, harnessing its electronic ink technology. Due to both the E Ink display and plastic substrate logic transistors, the display is also extremely low power, since it only draws power when the screen makes an update. Liquid Crystal Display (LCD) flexible displays have also been manufactured.

Circuit logic on flexible substrate is then bendable or conformable. Electronic components are mounted on, or printed on, flexible plastic substrates, usually made of polyether ether keytone (PEEK), an organic thermoplastic, polyimide, or transparent conductive polyester film. They've been used in watches, cameras, cellphones, and several small and/or portable consumer devices, as well as automotive and aerospace applications.

Applications for flexible color plastic screen technology extend to e-reader displays and to conformable signage or conformal screens in medical applications. The screens' daylight readability in bright and dim light would be a benefit in both of those applications, as well as in mobile electronics.

Some companies have introduced curved OLED televisions with a curved or flexed OLED display. These are the first applications and they are growing.

The concept of developing a flexible display was first put forth by Xerox PARC (Palo Alto Research Company). In 1974, Nicholas K. Sheridon, a PARC employee, made a major breakthrough in flexible display technology and produced the first flexible e-paper display.

In 2005, Arizona State University opened a 250,000 square foot facility dedicated to flexible display research named the ASU Flexible Display Center (FDC). ASU in partnership with Hewlett Packard finally demonstrated a prototype flexible e-paper from the Flexible Display Center at the university. HP continued on with the research, and in 2010, showcased another demonstration. However, due to limitations in technology, HP stated their goal was to make displays thinner and lighter.

Some manufactures offer color and monochrome plastic flexible displays in various sizes based on proprietary organic thin film transistor (OTFT) technology, capitalizing on their high volume manufacture of organic electronics. These flexible displays are cited as being “unbreakable”, because they are made completely of plastic and do not contain glass. They are also lighter and thinner than glass-based displays and low-power. Applications of this flexible display technology include signage, wristwatches and wearable devices as well as automotive and mobile devices.

What is needed are ways to take further advantage of the flexible display technology for lighting with use for the digital aspects of these emerging flexible logic display technologies. What is needed is lighting fixture technology that can migrate current lighting solutions from the current more mundane but standard lighting fixture solutions to the modern age of digital lighting. Hence what is needed are lighting devices that have added functionality with the usual illumination provided.

### SUMMARY

The present invention discloses a Digital Lampshade Display system comprising a supporting a lamp fixture with stand structurally coupled to the base and with conventional light fixture on the stand supporting a 3D conformable surface flexible display. The base lighting unit contains electronic components and circuit logic which controls the functions for the flexible 3D conformable surface display having external and internal surfaces for light emission, the display surface configured as a lampshade surrounding the conventional light fixture. The display light emitting layers are coupled to a flexible display interface (FDI) logic for digital image screen loads and other display control functions, which is electronically controlled by the flexible display interface, electronically coupled to a main control console, the display interface having components and logic for digital communication coupling the display to the control console. The main control console having executable digital control components, communication protocol and logic coupled to a wire/wireless communication facility for loading, displaying, downloading and storing image files from digital media sources, the communication facility with electronic components, communication protocol and logic for loading and downloading digital images to the control console for routing onto the flexible display interface and or media storage, and the lampshade display physically configured for emitting diffuse light and displaying of images via the wired or wireless communication facility electronic components and logic, whereby a flexible display screen for emitting diffuse light as a lampshade around a conventional light can also display downloaded static and video images.

### BRIEF DESCRIPTION OF DRAWINGS

Specific embodiments of the invention will be described in detail with reference to the following figures.

FIG. 1 is an illustration of a Digital Lampshade Display, according to the embodiment of the present invention.

FIG. 2 is an overhead illustration of a Digital Lampshade Display.

FIG. 3 is a cut-away illustration of a Digital Lampshade Display, detailing a connection to a companion lamp via USB.

FIG. 4 is an illustration of a Companion Lamp, for a Digital Lampshade Display.

FIG. 5 is a bottom illustration of a Companion Lamp, for a Digital Lampshade Display.

FIG. 6 is an illustration of a Smartphone being used as a remote control, to select a pattern to display a Digital Lampshade Display.

FIG. 7 is an illustration of a Retro-fit Digital Lampshade Display for an existing lamp base.

FIG. 8 is an illustration of a Tabletop Lamp with a Digital Lampshade Display, and containing a Built-in Alarm Clock.

FIG. 9 is an illustration of a Tabletop Lamp with a Digital Lampshade Display, and containing a Built-in Alarm Clock; detailing the lamp's base.

FIG. 10 is an illustration of a Tabletop Lamp with a Digital Lampshade Display, and containing a Cup Warmer; detailing the lamp's base.

FIG. 11 is an illustration of an Orb-Shaped Digital Lampshade Display.

FIG. 12 is an illustration of a Porch Light Digital Display.

FIG. 13 is an illustration of a Light Sconce Digital Display.

### DETAILED DESCRIPTION

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

The typical lampshade is a fixture that covers the light bulb on a lamp to diffuse the light it emits. Most lampshades are conical or cylindrical in form, and may be mounted onto floor, desk, wall or tabletop lamps, as well as suspended lamp models. Lampshades can be made from a wide range of materials, including glass. Beyond its practical purpose, significant emphasis is also usually given to the lampshade's decorative and aesthetic features. An object of the invention is to migrate from the standard lighting solution to the digital age of lighting solutions.

### Objects and Advantages

The present invention discloses the world's first Digital Lampshade Display using new lighting and display technologies from flexible display substrates.

It is an object of the invention to provide a lighting technology that will provide a for the standard lamp fixtures, which may be operated with or without a light bulb in a standard lamp.

It is another object of the invention to generate emitted light from both its exterior and interior surface(s).

It is another object of the invention for a lamp that will provide the user with a display upon which digital images and non-static motion imagery may be viewed.

It is yet another object of the invention allow the user to download images and motion imagery onto the lamp and to change a room's decorative and aesthetic feel.

It is an object of the invention to provide the user the ability to change the color, design, pattern, and illumination characteristics of their lampshade(s) to suit their needs.

The invention light emanates from digital lampshade display system (DLD) which is flexible and conformable to 3D surfaces of many types. The DLD contains one or more USB connectors to connect to a companion lamp when not being used with a standard lamp. The DLD will also have a Wireless Communication Facility which will pair with a companion Wireless Remote Control which will allow the user to use the Wireless Remote Control to control the DLD's functions such as: tuning the lampshade ON or OFF, adjusting brightness and/or contrast, selecting images to display, etc. The DLD will have logic and programming to allow the user to download a software application from the Internet in order to interact/interface with the lampshade. Where the regular lamp is also used in the lamp fixture, the DLD will have a layer of fabric on its exterior surface; allowing the lampshade to function as a regular lampshade when the power is turned off.

### EMBODIMENTS OF THE INVENTION

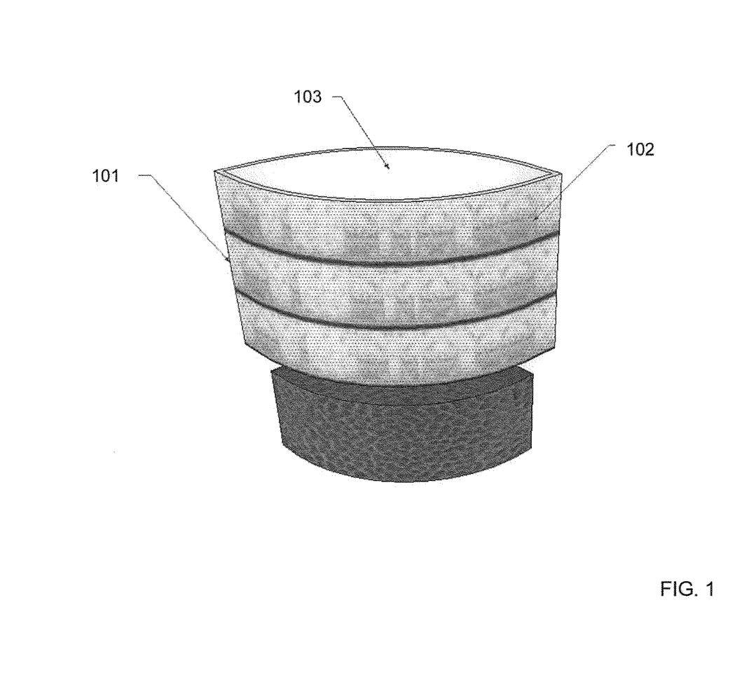

FIG. 1 illustrates and two sided 3D surface embodiment of the invention Digital Lampshade Display 101 with and exterior surface 102 and interior surface 103.

The Digital Lampshade Display 101 may be made from Flexible Organic Light Emitting Diodes (OLED), Active-Matrix Organic Light-Emitting Diodes (AMOLED), Organic Light Emitting Transistors (OLET), using organic thin-film transistors (OTFTs) with backplane of polyethylene terephthalate (PET), Flexible E-Ink or any other flexible display technology. The light emitting layers are interfaced with flexible display interface (FDI) logic for digital image screen loads from various sources. The display surface is conformable around the exterior of a given 3D surface shape. In this embodiment, the Digital Lampshade Display 101 may contain at least one emissive layer on the Exterior Surface 102, of the Digital Lampshade Display; and at least one emissive layer on the Interior Surface 103, of the Digital Lampshade Display. In this embodiment, the Digital Lampshade Display may emit light from both its Exterior Surface 102 and its Interior Surface 103. In this embodiment, the user may upload and view both static and/or full motion digital imagery on the Exterior Surface of the Digital Lampshade Display. In this embodiment, the Digital Lampshade Display may be operated with or without the use of a light bulb.

USB or other communication standard devices couple to a companion lamp. The Wireless Communication Facility provide the functionality to pair with a companion Wireless Remote Control which will allow the user to use the Wireless Remote Control to control the DLD's functions such as: turning the lampshade ON or OFF, adjusting brightness and/or contrast, selecting images to display, etc. DLD base housing contains a Wired or Wireless Communication Facility which comprise the electronic components and logic to provide communication and user function and control to download images from the Internet and other external sources in order to interact/interface with the lampshade. In this embodiment, the Digital Lampshade Display may be operated optionally with conventional light bulb.

A preferred embodiment of the invention has a base lighting unit for housing electronic components and circuit logic, a supporting a lamp fixture stand structurally coupled to the base and with conventional light fixture on the stand also supporting and coupled to a 3D conformable surface flexible display, the flexible 3D conformable surface display having external and internal surfaces for light emission, the display surface configured as a lampshade surrounding the conventional light fixture, the light emitting layers are coupled to a flexible display interface (FDI) logic for digital image screen loads and other display control functions, the flexible display interface is coupled a main control console, the display interface having components and logic for digital communication coupling the display to the control console, the main control console with executable digital control components, communication protocol and logic is coupled to a wire/wireless communication facility for handling user interface both local and remote, loading, displaying, downloading and storing image, video and audio files from digital media sources, the communication facility with electronic components, communication protocol and logic for loading and downloading digital images via wired or wireless standard protocol communication facility electronic components and logic to the control console for routing onto the flexible display interface and or media storage, and the lampshade display physically configured for emitting diffuse light and for displaying images and video received via the communication facility,

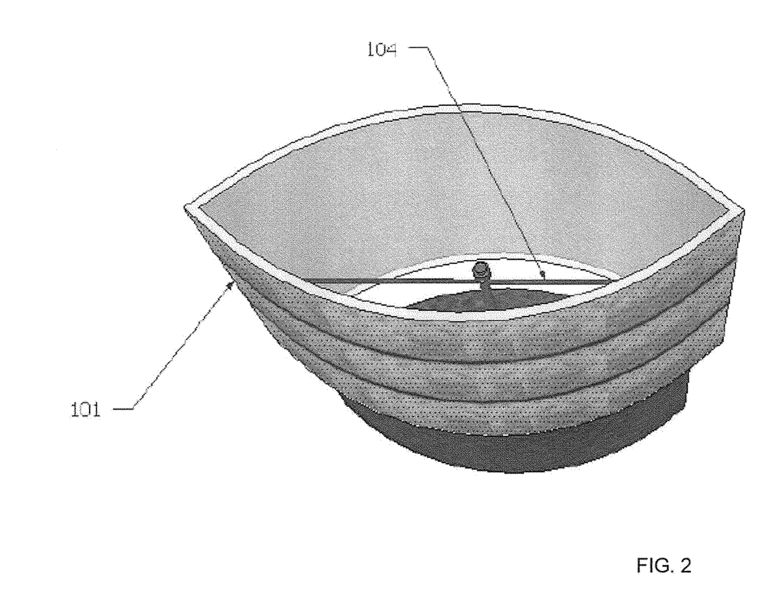

FIG. 2 is an overhead illustration of a Digital Lampshade Display. In one embodiment, the internal structure of the Digital Lampshade Display may contain a Rigid Frame 104. In one embodiment, the Rigid Frame may be made from metal, plastic, fiber or any other viable, rigid composite material. In one embodiment, the Rigid Frame may be hollow to allow for the storing of electrical and data wiring to provide electrical connectivity to the Digital Lampshade Display; and for the transferring of electronic images to be displayed on the Exterior Surface of the Digital Lampshade Display.

In another embodiment, the Digital Lampshade Display may contain a semi-transparent layer of fabric or any other viable type of decorative material, which may be wrap coupled over the Exterior Surface of the Digital Lampshade Display. In this embodiment, the semi-transparent layer of wrapping fabric may give the Digital Lampshade Display the appearance of a normal lampshade when it is powered OFF. In another embodiment, the static and/or full motion digital imagery which is displayed on the Exterior Surface of the Digital Lampshade Display may be visible through the semi-transparent layer of fabric when the Digital Lampshade Display is powered ON.

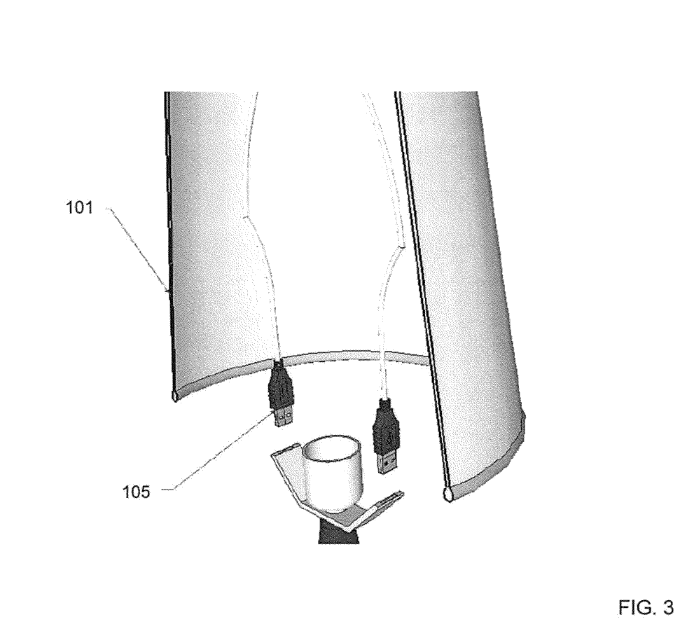

FIG. 3 is a cut-away illustration of a Digital Lampshade Display 101, detailing a connection to a companion lamp via USB connector(s) 105. In one embodiment, the Digital Lampshade Display may contain USB connector(s), which are structurally and electrically coupled to the Rigid Frame. In this embodiment, power and static and/or full motion digital imagery are supplied to the Digital Lampshade Display via the standard connectors.

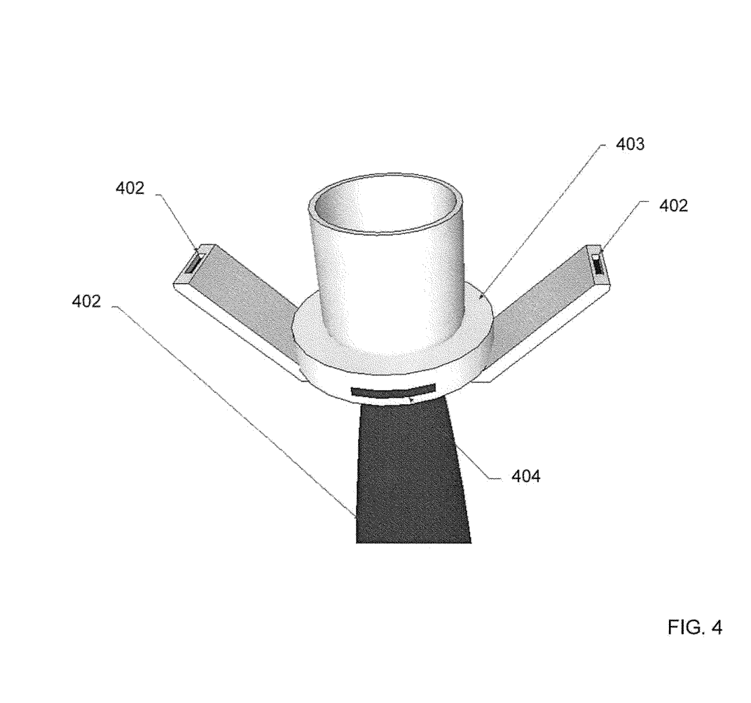

FIG. 4 is an illustration of a Companion Lamp 401 for a Digital Lampshade Display, according to an embodiment of the present invention. In this embodiment, the Companion Lamp DLD is coupled to power and signal via standard available ports such as USB Port(s) 402. In one embodiment, the USB Connectors, which are connected to the Rigid Frame on the Digital Lampshade Display, may be plugged into the USB Port(s). In this embodiment, power and static and/or full motion digital imagery may be supplied to the Digital Lampshade Display interface logic.

In another embodiment, the Companion Lamp may also contain a Wireless Communication Facility 403. In one embodiment, the user may pair their computer or Smartphone to the Wireless Communication Facility via Bluetooth, Wi-Fi or any other viable wireless frequency. In this embodiment, the user may upload or remove static and/or full motion digital imagery to/from the Companion Lamp. In another embodiment, the user may use their paired computer or Smartphone to access the internet, where preset images or animations may be downloaded from a specific website to be viewed on the Digital Lampshade Display. In another embodiment, the user may download or stream a specific theme, such as a movie theme, to be displayed on the Digital Lampshade Display. In another embodiment, the user may engage their paired computer or Smartphone to control the Digital Lampshade Display's functions. These functions are typical display functions such as turning the display ON/OFF, selecting display brightness, selecting images to display, etc.

In another embodiment, the Companion Lamp may also contain a Data Port 404 such as a memory card reader or any other standard type of media reader. In this embodiment, the user may use the Data Port to load images, patterns, video files, etc. onto the Companion Lamp storing logic.

In another embodiment, the Companion Lamp embodiment may also contain a Touch Sensitive Illuminated Control Pad 404. In this embodiment, the user may touch the Touch Sensitive Illuminated Control Pad with a finger to adjust the lighting level of the Digital Lampshade Display and/or the light bulb.

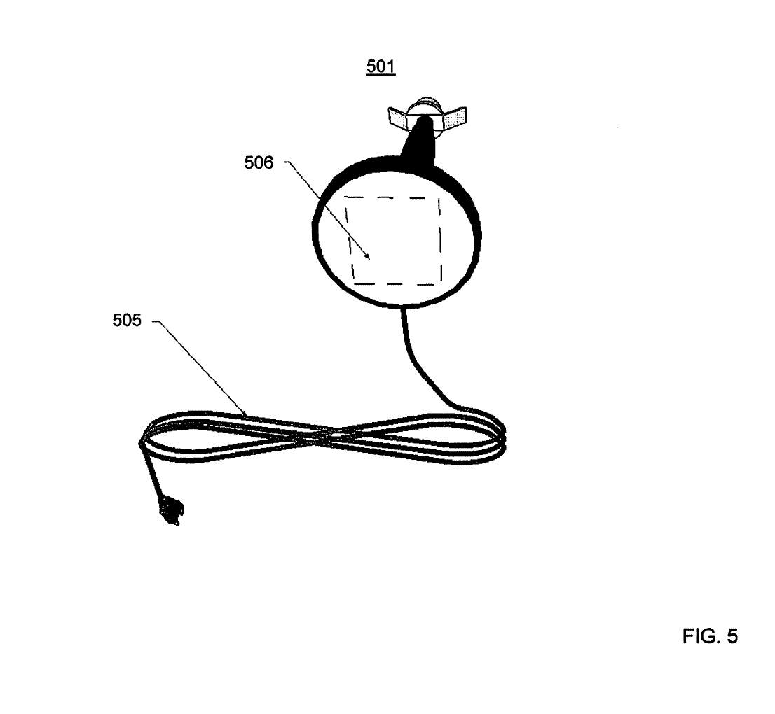

FIG. 5 is a bottom view illustration of a Companion Lamp 501, for a Digital Lampshade Display system. In another embodiment, the Companion Lamp may contain a Retractable Power Cord 505. In one embodiment, the user may extend the Retractable Power Cord from the base of the Companion Lamp and plug it into an electrical outlet to supply power to the Companion Lamp and/or the Digital Lampshade Display. In another embodiment, the user may unplug the Retractable Power Cord from an electrical outlet and retract it into the base of the Companion Lamp. In this embodiment, the Companion Lamp and/or the Digital Lampshade Display may be powered via an Internal Rechargeable Battery 506. In one embodiment, the Internal Rechargeable Battery may be charged/recharged when the Retractable Power Cord is plugged into an electrical outlet. In another embodiment, when the Internal Rechargeable Battery is charged, power may be supplied to the Companion Lamp and/or the Digital Lampshade Display. In this embodiment, the Internal Rechargeable Battery may provide power to the Companion Lamp and/or the Digital Lampshade Display during a power outage, or when the Companion Lamp and/or the Digital Lampshade Display is being used in an area where an electrical outlet is not available, thus behaving as a backup power supply.

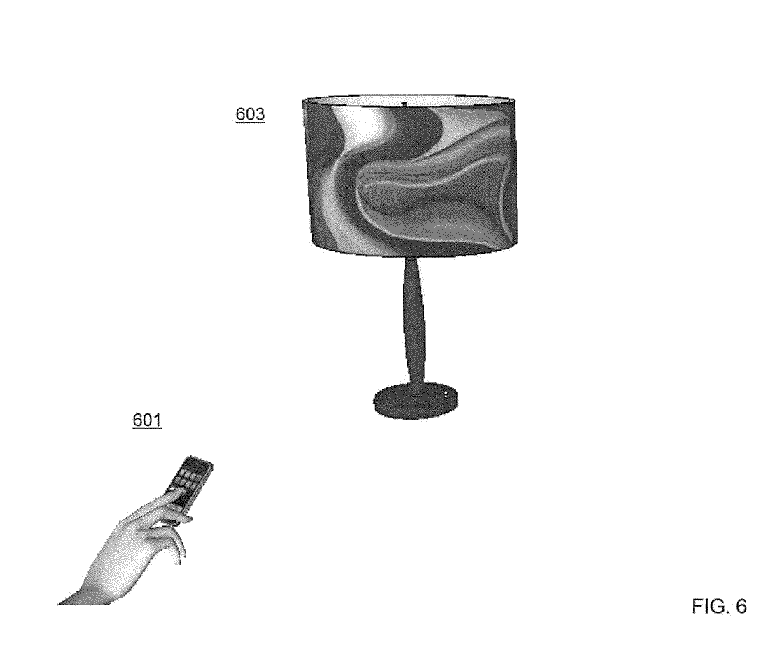

FIG. 6 is an illustration of a Smartphone 601 being used as a remote control, to select a pattern to display a Digital Lampshade Display 603. The smartphone 601 use any wireless standard such as WiFi, Bluetooth, movement sensitive sensors and other to communicate with the reception digital components and protocol logic integrated in the DLD 603.

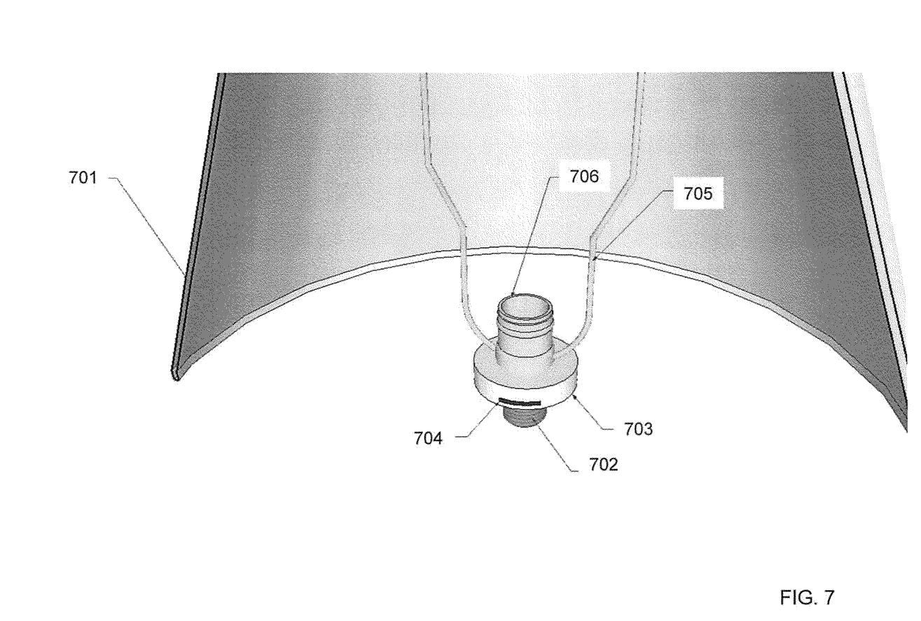

FIG. 7 is a cut-away view illustration of a Retro-fit Digital Lampshade Display system 701, for an existing lamp base. In another embodiment, the Retro-fit Digital Lampshade Display may contain all of the embodiments described above; however, in this embodiment, the Retro-fit Digital Lampshade Display may be designed to fit onto any existing lamp base on the legacy market bridging the old lamps to the DLD technology. In one embodiment, the Retro-fit Digital Lampshade Display may contain a Threaded Male Socket Cap 702. In this embodiment, the user may screw insert the Threaded Male Socket Cap into a threaded light female socket on standard existing lamp base light sockets on the market. In this embodiment, power may be supplied to the Retro-fit Digital Lampshade Display from the old lamp socket to power the DLD and associated digital functionality such as data sockets, wireless communication, switches and more. In related embodiment, the Retro-fit Digital Lampshade Display may contain Wireless Communication Facility 703. In one embodiment, the Wireless Communication Facility may contain all of the embodiments and functions described above.

In another embodiment, the Retro-fit Digital Lampshade Display may contain a Touch Sensitive Illuminated Control Pad 704. In one embodiment, the user may touch the Touch Sensitive Illuminated pad 704 in pre-set ways for control, tapping once, twice, trice, etc for diming, increasing light, turning off/on, respectively, etc to adjust the lighting level of the Digital Lampshade Display and/or the light bulb.

In another embodiment, the Retro-fit Digital Lampshade Display may contain a Rigid Frame 705, which may be rigidly coupled to the Wireless Communication Facility and may support the Retro-fit Digital Lampshade Display. In one embodiment, the Rigid Frame 705 may be made from metal, plastic, composite or any other viable lampshade physical supporting material. In another embodiment, the Rigid Frame 705 may be hollow tube to allow for the storing of electrical and data wiring to provide electrical and electronic connectivity to the Retro-fit Digital Lampshade Display from logic and programming components for the transferring of electronic images to be displayed on the Exterior Surface of the Retro-fit Digital Lampshade Display.

In another embodiment, the Retro-fit Digital Lampshade Display may contain a female Threaded Light Socket 706 for insertion of conventional legacy light bulb into the Threaded Light Socket to provide additional illumination to that of the Retro-fit Digital Lampshade Display. In another embodiment, the user may inset a light bulb into the femalae Threaded Light Socket 706 to provide illumination without the use of the Retro-fit Digital Lampshade Display.

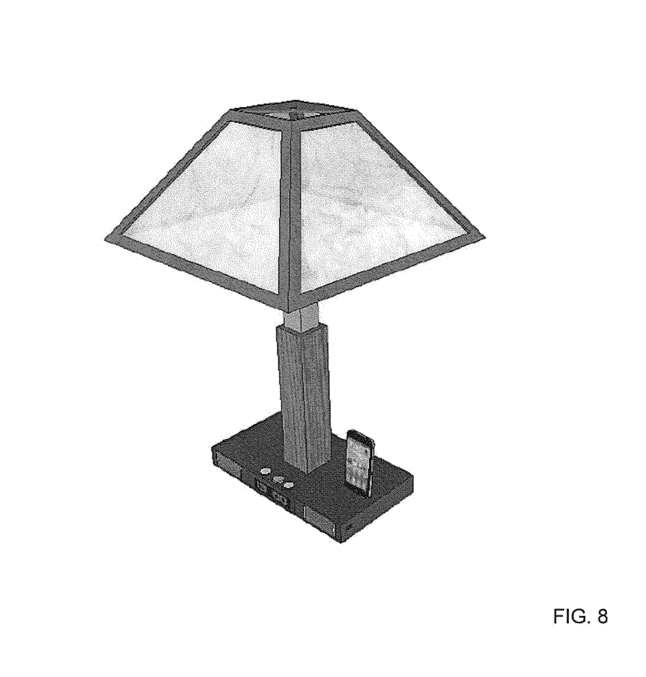

FIG. 8 is an illustration of a Tabletop Lamp with a Digital Lampshade Display, and coupled to a Built-in Alarm Clock and smartphone docking station at the lamp base. The base housing can also support interfaces for other consumer devices such as video and sensor digital alarm systems, intercom, and stereo systems such that content from standalone devices can be transferred for display on the lampshade or audio to lamp base speakers.

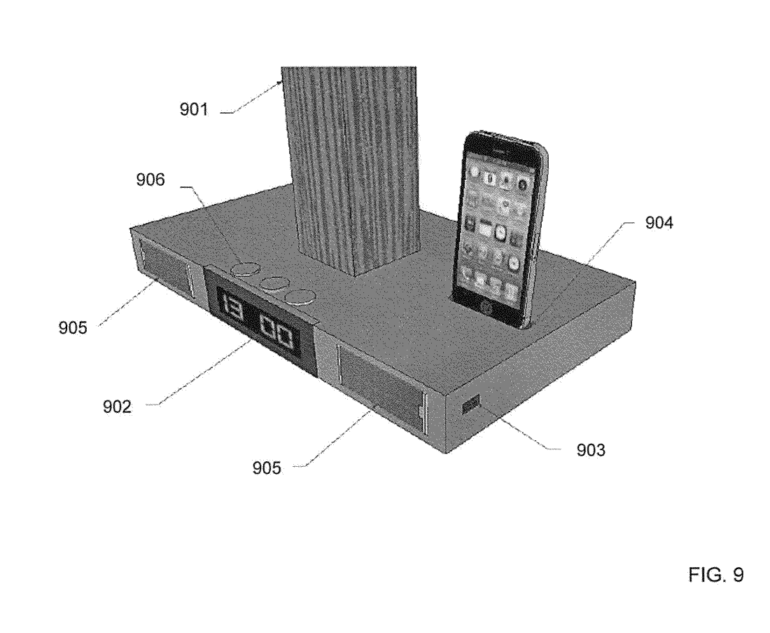

FIG. 9 is an illustration of a Tabletop Lamp 901, with a Digital Lampshade Display, and containing Built-in or integrated utilities such as Alarm Clock 902 with detailing the lamp's base. In an embodiment, the Tabletop Lamp 901 utilities may contain a Built-in Alarm Clock 902 coupled to the DLD to be settable to synchronize with a users pre-set programmable scheduling; providing users capability to program the Digital Lampshade Display to automatically turn ON with a set alarm on the Built-in Alarm Clock. In another embodiment will include a console interface for downloading specific graphics or full motion video and audio, such as the sun rising or crashing waves. Programming may be set to be displayed along with music selected by the user, coupled to the standard wireless and wired stored content components and interfaces.

In an embodiment, the DLD system integrated components will include DLD integrated components and facilities to upload and save music to the Built-in Alarm Clock via Data Port 903. In this embodiment, the Data Port may be a USB Port, mini USB, micro USB, memory card reader, or any other viable data port technology.

In another embodiment, the Tabletop Lamp integrated utilities may contain a Cradle 904, to provide a Smartphone docking station, Cell Phone, MP3 Player, intercomm, stereo, etc. to the Tabletop Lamp. In this embodiment, the user may through remote or console 905 access audio files which they have stored on their docked Smartphone, Cell Phone, MP3 Player, etc. for playing audio files through the Tabletop Lamp's Speaker(s) 905. In another embodiment, the user may set the Tabletop Lamp to alarm and play audio files from their docked Smartphone, Cell Phone, MP3 Player, etc. In another embodiment, the Built-in Alarm Clock may be set to automatically synchronize to any alarm that is set on the user's docked Smartphone, cell phone, MP3 Player, alternate audio device, etc.

Tabletop Lamp base houses electronic components couple Control Console Button(s) 906, for typical functionality to control or adjust any audio being played on the Tabletop Lamp. The control interface can be of the touch screen type with touch tapable buttons and analogous with a smartphone touch screen interface. The user may alternatively control or adjust any audio being played on the Tabletop Lamp with a wireless remote.

In another embodiment, the Tabletop Lamp will contain a Cradle 904 for docking various consumer devices such as a Smartphone, Cell Phone, MP3 Player, etc. to the Tabletop Lamp. In this embodiment, the user will access audio files through the standard interfaces and logic for retrieving stored audio on their docked Smartphone, Cell Phone, MP3 Player, etc. For playing of those audio files through the Tabletop Lamp's Speaker(s) 905. In another embodiment, the user may set the Tabletop Lamp to alarm and play audio files from their docked Smartphone, Cell Phone, MP3 Player, etc. In another embodiment, the Built-in Alarm Clock may be set to automatically synchronize to any alarm that is set on the user's docked Smartphone, Cell Rhone, MP3 Player, etc.

In another embodiment, the user may use Console Control Button(s) 906, to control or adjust any audio being played on the Tabletop Lamp. In another embodiment, the user may control or adjust any audio being played on the Tabletop Lamp with a wireless remote.

In another embodiment, the base will house logic and components to provide access to photos and/or video files which they have stored on docked Smartphone, Cell Phone, MP3 Player, etc. For display those photos and/or video files on the Tabletop Lamp's Digital Lampshade Display. In another embodiment, the Tabletop Lamp will contain standard compliant components and interface logic for programming the alarm and to display photos and/or video files from their docked Smartphone, Cell Phone, MP3 Player, etc. on the Tabletop Lamp's Digital Lampshade Display

In another embodiment, the user may use Console Control Button(s) 906 interface, to control or adjust any photos and/or video files being played on the Tabletop Lamp's Digital Lampshade Display. In another embodiment, the DLD interface will provide functionality to control or adjust any photos and/or video files being played on the Tabletop Lamp's Digital Lampshade Display with a wireless remote.

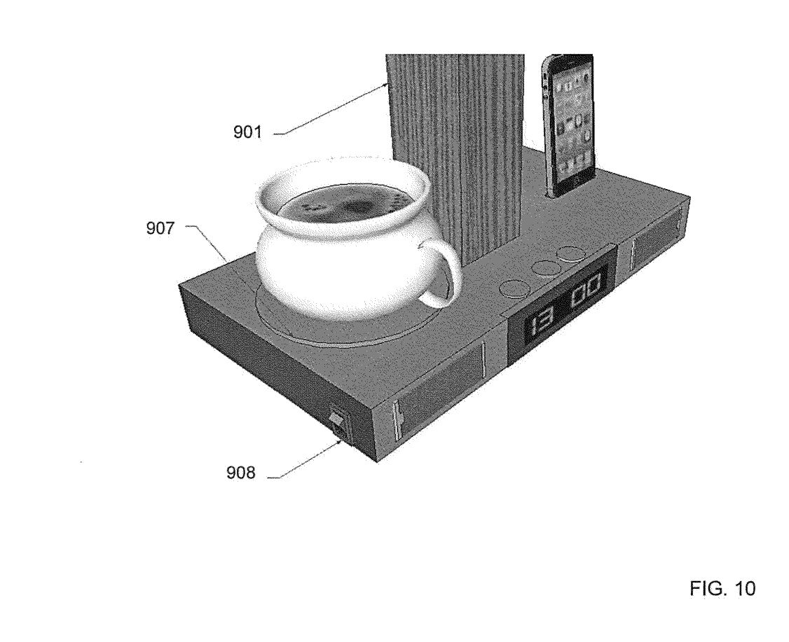

FIG. 10 is an illustration of a Tabletop Lamp 901, only base of the Digital Lampshade Display shown, and containing a Cup Warmer 907; detailing the lamp's base. This embodiment Tabletop Lamp will contain utilites and functionalities from other embodiment with addition of an electrically coupled device such as a Cup Warmer 907. In one embodiment, the cup warmer 907 having the typical hot plate controls to be used in keeping a cup containing a hot beverage such as coffee or tea at a set temperature. In another embodiment, Cup Warmer ON/OFF Switch 908, etc.

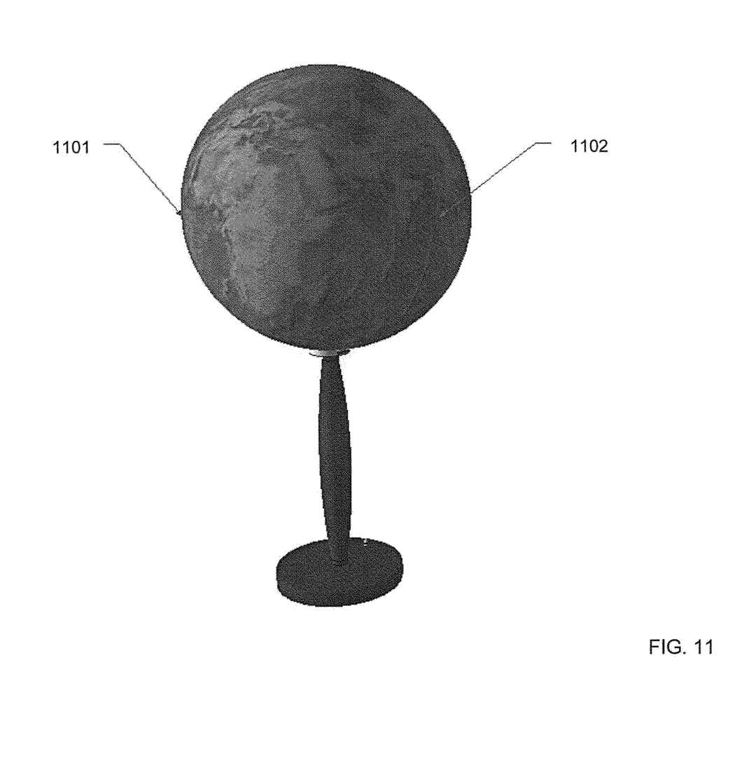

FIG. 11 is an illustration of an Orb-Shaped Digital Lampshade Display 1101. In an embodiment of the invention, the Digital Lampshade Display is 3D surface shape conformable and the sphere or orb is one such shape. The Orb-Shaped Digital Lampshade Display will display images on it's 3D Exterior Surface. The images may themselves be of 3D spherical form such as images of the Earth, Moon, or any other planet. An embodiment of DLD touch screen sensitive would provide an Interactive Touch screen Globe. In this embodiment, the Orb-Shaped Digital Lampshade Display may contain proprietary software coupled to standard image transfer interfaces for sources on internet via wired or wireless connection providing realtime display satellite images having weather content such as storms, clouds, etc. In another embodiment, the Orb-Shaped Digital Lampshade Display will contain components, logic, programming and interfaces for software which may allow for 24-Hour Solar Cycle Display and Tracking 1102, in real-time. In this embodiment, the Orb-Shaped Digital Lampshade Display may display the day/night cycle, by displaying one area of the Earth in light and the other in darkness. In another embodiment, the proprietary software may cause the image being displayed on the Exterior Surface of the Orb-Shaped Digital Lampshade Display will provide a moving image with the appearance of a rotation.

In another embodiment, the DLD will integrate components, logic, communication standard protocol interfaces to provide for the download and install interactive application software, such as Google Earth for example, to the Orb-Shaped Digital Lampshade Display. In this embodiment, the Orb-Shaped Digital Lampshade Display will have an exterior touch screen interface to provide the user with a three dimensional, interactive experience; allowing the user to touch on selected geographic areas to view data, points of interest, photos, etc.

In another embodiment, the Digital Lampshade Display will download an image for a spherical pattern to be displayed conforming to a DLD sphere shape exterior surface. In one example, the bauble may be a Christmas ornament or any other type of decorative ornament.

In one embodiment, a bauble may contain a Plug-In Module (such as USB) to allow it to be quickly plugged and unplugged from a cable. In this embodiment, the Plug-In Module may allow the user to connect the bauble to a cable to download static and/or full motion digital imagery. In another embodiment, the user may download static and/or full motion digital imagery to the bauble via Wi-Fi, or any other viable wireless frequency so that the bauble can be installed without the cable.

In another embodiment, the bauble(s) may be suspended together from a cable. In one embodiment, one end of the cable may be plugged into an electrical outlet, while the rest of the cable may be hung on/around a Christmas tree. In this embodiment, power may be provided to the bauble(s) to display the static and/or full motion digital imagery.

In another embodiment, the bauble may contain an Internal Battery with an Internal Battery which may be charged/recharged when the bauble is plugged into the cable. In another embodiment, when the Internal Battery is fully charged, the user may disconnect the bauble(s) from the cable and hang them up anywhere. In this embodiment, the disconnect bauble may display static and/or full motion digital imagery for as long as the Internal Battery maintains a charge.

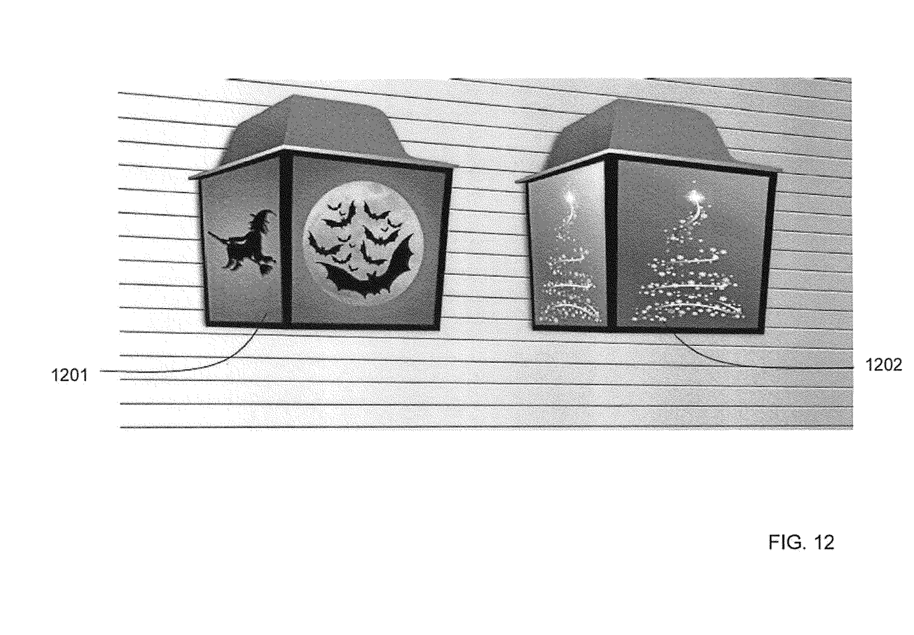

FIG. 12 is an illustration of a Porch Light Digital Display 1201, according to the embodiment of the present invention. In one embodiment, the Porch Light Digital Display may be made from glass, plastic or any other viable material. In one embodiment, the Porch Light Digital Display may contain all of the embodiments described above. In another embodiment, the digital display may be either integrated into the Porch Light Digital Display or adhered to its Exterior or Interior Surface. In another embodiment, all of the electronic components, wiring, etc. may be housed inside of the Porch Light Digital Display's Rigid Frame and may provide a seamless look when installed, appearing like a regular porch light but having the DLD functionality. In another embodiment, the user may download via wireless protocol, eg Wi-Fi, a specific theme such as a holiday theme, to be displayed on the Porch Light Digital Display.

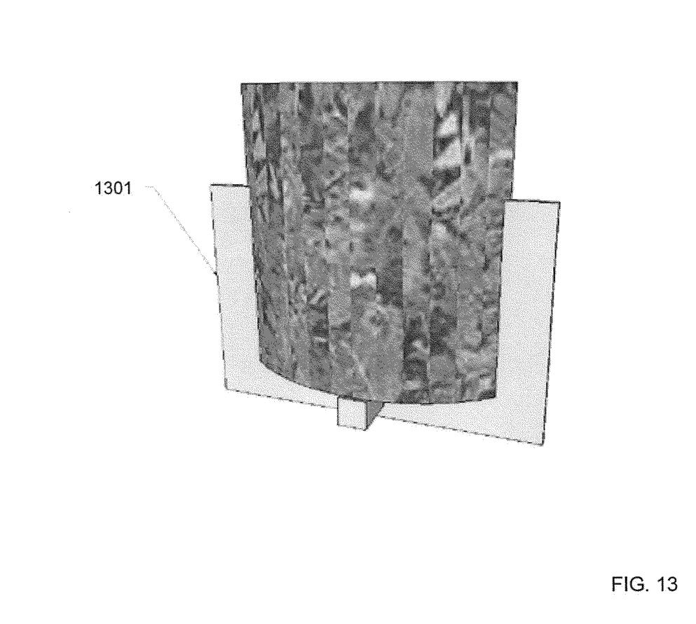

FIG. 13 is an illustration of a Light Sconce Digital Display 1301, according to the embodiment of the present invention. In one embodiment, the Light Sconce Digital Display may be made from glass, plastic or any other viable material. In one embodiment, the Light Sconce Digital Display may contain all of the embodiments described above. In another embodiment, the digital display may be either integrated into the Light Sconce or adhered to its Exterior or Interior Surface. In another embodiment, all of the electronic components, wiring, etc. may be housed inside of the Light Sconce Digital Display's Rigid Frame and may provide a seamless look when installed. In another embodiment, the user may download via wireless protocol, eg WiFi, a specific theme (such as a holiday theme) to be displayed on the Light Sconce Digital Display.

Therefore, while the invention has been described with respect to a limited number of embodiments, those skilled in the art, having benefit of this invention, will appreciate that other embodiments can be devised which do not depart from the scope of the invention as disclosed herein. Other aspects of the invention will be apparent from the following description and the appended claims.

What is claimed is:

1. A Digital Lampshade Display system comprising:
a base lighting unit for housing electronic components and circuit logic,
a supporting a lamp fixture stand structurally coupled to the base and with conventional light fixture on the stand also supporting and coupled to a 3D conformable surface flexible display,
the flexible 3D conformable surface display having external and internal surfaces for light emission, the display surface configured as a lampshade surrounding the conventional light fixture,
the light emitting layers are coupled to a flexible display interface (FDI) logic for digital image screen loads and other display control functions,
the flexible display interface is coupled a main control console, the display interface having components and logic for digital communication coupling the display to the control console,
the main control console with executable digital control components, communication protocol and logic is coupled to a wire/wireless communication facility for handling user interface both local and remote, loading, displaying, downloading and storing image, video and audio files from digital media sources,
the communication facility with electronic components, communication protocol and logic for loading and downloading digital images via wired or wireless standard protocol communication facility electronic components and logic to the control console for routing onto the flexible display interface and or media storage, and
the lampshade display physically configured for emitting diffuse light and for displaying images and video received via the communication facility,
whereby a flexible display screen for emitting diffuse light as a lampshade around a conventional light can also display downloaded static and video images.

2. The Digital Lampshade Display system as in claim 1 wherein the flexible display technology is chosen from essentially a set of flexible display layer technologies consisting of Organic Light Emitting Diodes (OLED), Active-Matrix Organic Light-Emitting Diodes (AMOLED), Organic Light Emitting Transistors (OLET), organic thin-film transistors (OTFTs) with backplane is made of polyethylene terephthalate (PET), E-Ink, LCD and other conformable plastic substrates with embedded circuitry.

3. The Digital Lampshade Display system as in claim 1 further comprising at least one emissive layer on the Exterior Surface and at least one emissive layer on the Interior Surface for emitting diffuse light from either or both of its Exterior Surface and its Interior Surfaces.

4. The Digital Lampshade Display system as in claim 1 wherein the flexible display digital interface electronic components and logic functions provide image and audio/video file downloads for viewing of both static and/or full motion digital imagery on the Exterior Surface flexible display.

5. The Digital Lampshade Display system as in claim 1 wherein the Digital Lampshade Display may be operated with or without the use of a conventional light bulb in the standard light socket fixture.

6. The Digital Lampshade Display system as in claim 1 wherein the conformably bent 3D surface shape surface are selected from a group of 3D surfaces consisting essentially of lampshade conic sections, axially symmetric conic sections, spheres, orbs, oval shape, parallelepiped, cube, light sconce, porch light, and combinations.

7. The Digital Lampshade Display system as in claim 1 wherein the communication facility can communicate with the standard wire and wireless communication standards from the set of communication standards consisting essentially of USB, Wi-Fi, Bluetooth, Cellular, NFC and ISO standard communications.

8. The Digital Lampshade Display system as in claim 1 further comprising a base housing with interfaces for consumer devices and with and without external sources of media content from the set of consumer devices consisting essentially of smartphones, cellphones, MP3 players, video and sensor digital alarm systems, intercoms, stereo systems, radio, hot plate, and cup warmer.

9. The Digital Lampshade Display system as in claim 1 wherein the power supply can be rechargeable as well as battery or power grid.

10. A method of creating Digital Lampshade Display system comprising the steps of:
providing a base lighting unit for housing electronic components and circuit logic,
structurally coupling a lamp fixture stand to the base and with conventional light fixture on the stand for supporting and coupled to a 3D conformable surface flexible display,
configuring the flexible 3D conformable surface display having external and internal surfaces for light emission as a lampshade surrounding the conventional light fixture,
coupling light emitting layers of the display to a flexible display interface (FDI) logic for digital image screen loads and other display control functions,
electrically coupling the flexible display interface to a main control console, the display interface having components and logic for digital communication coupling the display to the control console,
electronically coupling the main control console having executable digital control components, communication protocol and logic to a wire/wireless communication facility for handling user interface both local to the fixture and remote, loading, displaying, downloading and storing image, video and audio files from digital media sources via the communication facility,
loading and downloading digital images, audio and video content via wired or wireless standard protocol communication facility electronic components and logic to the control console for routing onto the flexible display interface and or media storage, and
configuring the lampshade display for emitting diffuse light and for displaying images and video received via the communication facility,
such that a flexible display screen for emitting diffuse light as a lampshade around a conventional light can also display downloaded static and video images.

11. The Digital Lampshade Display method as in claim 10 further comprising the steps of using the flexible display technology chosen from essentially a set of flexible display layer technologies consisting of Organic Light Emitting Diodes (OLED), Active-Matrix Organic Light-Emitting Diodes (AMOLED), Organic Light Emitting Transistors (OLET), organic thin-film transistors (OTFTs) with backplane is made of polyethylene terephthalate (PET), E-Ink, LCD and other conformable plastic substrates with embedded circuitry.

12. The Digital Lampshade Display method as in claim 10 further comprising the steps of integrating at least one emissive layer on the Exterior Surface and at least one emissive layer on the Interior Surface for emitting diffuse light from either or both of its Exterior Surface and its Interior Surfaces.

13. The Digital Lampshade Display method as in claim 10 further comprising the steps of using flexible display digital interface electronic components and logic functions for providing image and audio/video file downloads for viewing of both static and/or full motion digital imagery on the Exterior Surface flexible display.

14. The Digital Lampshade Display method as in claim 10 further comprising the step of operating the display with or without the use of a conventional light bulb in the standard light socket fixture.

15. The Digital Lampshade Display method as in claim 10 further comprising the step of bending the display surface shape to conform to a 3D surface selected from a group of 3D surfaces consisting essentially of lampshade conic sections, axially symmetric conic sections, spheres, orbs, oval shape, parallelepiped, cube, light sconce, porch light, and combinations.

16. The Digital Lampshade Display method as in claim 10 further comprising the step of providing communication facility for communication with the standard wire and wireless communication standards from the set of communication standards consisting essentially of USB, Wi-Fi, Bluetooth, Cellular, NFC and ISO standard communications.

17. The Digital Lampshade Display method as in claim 10 further comprising the step of building a base housing with interfaces for consumer devices and with and without external sources of media content from the set of consumer devices consisting essentially of smartphones, cellphones, MP3 players, video and sensor digital alarm systems, intercoms, stereo systems, radio, hot plate, and cup warmer.

18. The Digital Lampshade Display method as in claim 10 further comprising the step of integrating power supplies which can be rechargeable as well as battery or power grid.
